(19) United States
(12) Patent Application Publication
(10) Pub. No.: US 2017/0085500 A1
(43) Pub. Date: Mar. 23, 2017

(54) STREAMLINED PROCESSING IN A NETWORK SWITCH OF NETWORK PACKETS IN A SPLICED CONNECTION

(71) Applicant: Pluribus Networks, Inc., Palo Alto, CA (US)

(72) Inventors: Ritun Patney, San Mateo, CA (US); Sunay Tripathi, Palo Alto, CA (US); Bill Coates, Saratoga, CA (US)

(21) Appl. No.: 14/858,307

(22) Filed: Sep. 18, 2015

(51) Int. Cl. H04L 12/947; H04L 29/06; H04L 12/861; H04L 12/721

(52) U.S. Cl. CPC H04L 49/25; H04L 45/66; H04L 69/16; H04L 67/42; H04L 49/90

(57) ABSTRACT

Methods, systems, and computer programs are presented for splicing a client-server connection. One method includes an operation for splicing a client-server network connection by creating a first network connection between the client and a network device and a second network connection between the network device and the server. The method includes an operation for configuring in the network device a network processing unit (NPU) with a first and second offsets for the first and second network connections respectively. The incoming packets for the first and second network connections are then sent to the NPU for processing, which processes the packets in hardware to achieve low packet latency. The NPU adjusts the sequence number of the incoming packets of the first and second network connections based on the respective first and second offsets. The incoming packets are then sent to the destination after being processed.

### BACKGROUND

1. Field of the Invention

The present embodiments relates to methods, systems, and programs for managing network traffic, and more particularly, methods, systems, and computer programs for splicing a Transmission Control Protocol (TCP) connection.

2. Description of the Related Art

The proliferation of network devices has resulted in complex networking strategies to distribute packets in a network efficiently. In some solutions, multitier switching devices are used to build the network, but these complex multitier solutions do not provide an efficient distribution of packets at the level 2, and the management of these multitier switches is difficult and inflexible.

Sometimes a connection between a client and a server flows through an intermediate network switch, and the connection is split by creating two connections: one connection between the client and the network switch and a second connection between the network switch and the server. These connections are transparently spliced at the network switch and are referred to as splicing the connection.

However, the splicing off a connection requires extra resources at the network switch to maintain the two separate connections, and when the network switch is processing a large amount of traffic (e.g., thousands or millions of packets per second), splicing may result in increased latency and poor network performance.

It is in this context that embodiments arise.

### SUMMARY

Methods, devices, systems, and computer programs are presented for processing packets of a spliced Transmission Control Protocol (TCP) connection. It should be appreciated that the present embodiments can be implemented in numerous ways, such as a method, an apparatus, a system, a device, or a computer program on a computer readable medium. Several embodiments are described below.

One general aspect includes a method including splicing, by a network device, a client-server network connection between a client and a server by creating a first network connection between the client and the network device and a second network connection between the network device and the server. The method also includes configuring in the network device a network processing unit (NPU) with a first offset for the first network connection and a second offset for the second network connection. The method also includes configuring in the network device a switch fabric to send incoming packets for the first network connection and the second network connection to the NPU for processing. The method also includes adjusting, at the NPU, the sequence number of the incoming packets of the first network connection based on the first offset and adjusting the sequence number of the incoming packets of the second network connection based on the second offset, where the splicing of the client-server network connection is transparent to the client and the server, where the NPU is hardware of the network device, and the NPU is configured to adjust the sequence number of the incoming packets. The method also includes sending the incoming packets to a destination after the adjusting. Other embodiments of this aspect include corresponding computer systems, apparatus, and computer programs recorded on one or more computer storage devices, each configured to perform the actions of the methods.

Implementations may include one or more of the following features. The method as recited further including adjusting, at the NPU, an acknowledgment number of the incoming packets of the first network connection based on a first acknowledgment number offset value and adjusting an acknowledgment number of the incoming packets of the second network connection based on a second acknowledgment number offset value. The method may also include modifying, at the NPU, a checksum of the incoming packets after the adjusting. The method as recited where splicing the client-server network connection further includes performing a first three-way handshake between the client and the network device to create the first network connection. The method may also include performing, after performing the first three-way handshake, a second three-way handshake between the network device and the server to create the second network connection. The method as recited further including after performing the first three-way handshake, selecting the server from a plurality of servers. The method may also include performing the second three-way handshake with the selected server. The method as recited further including after adjusting the sequence number of the incoming packets, sending the incoming packets to the switch fabric. The method as recited further including performing, at the switch fabric, network address translation for the incoming packet. The method as recited where configuring the NPU further includes initializing a register in the NPU with the first offset, where the NPU accesses the register to adjust the incoming packets from the first network connection to perform the adjustment in hardware. The method as recited where adjusting the incoming packets of the first network connection includes changing the sequence number of the incoming packets of the first network connection to be incremented by the first offset. The method as recited where the client-server network connection, the first network connection, and the second network connection are transmission control protocol (TCP) connections, where the sequence number is a TCP sequence number.

One general aspect includes a network device including a network processing unit (NPU) for processing packets in the network device. The network device also includes a switch fabric for processing packets within the network device. The network device also includes a processor configured to splice a client-server network connection between a client and a server by creating a first network connection between the client and the network device and a second network connection between the network device and the server. The processor configures the NPU with a first offset for the first network connection and a second offset for the second network connection, and the processor configures the switch fabric to send incoming packets for the first network connection and the second network connection to the NPU for processing. Further, the NPU is configured to adjust the sequence number of the incoming packets of the first network connection based on the first offset and adjust the sequence number of the incoming packets of the second network connection based on the second offset, where the splicing of the client-server network connection is transparent to the client and the server, where the NPU is hardware of the network device, and the NPU is configured to adjust the sequence number of the incoming packets. The switch fabric is configured to send the incoming packets to a destination after the NPU adjusts the sequence number of the incoming packets.

One general aspect includes a non-transitory computer-readable storage medium storing a computer program for processing network packets at a network device, the computer-readable storage medium including program instructions for splicing, by a network device, a client-server network connection between a client and a server by creating a first network connection between the client and the network device and a second network connection between the network device and the server. The storage medium also includes program instructions for configuring in the network device a network processing unit (NPU) with a first offset for the first network connection and a second offset for the second network connection. The storage medium also includes program instructions for configuring in the network device a switch fabric to send incoming packets for the first network connection and the second network connection to the NPU for processing. The storage medium also includes program instructions for adjusting, at the NPU, the sequence number of the incoming packets of the first network connection based on the first offset and adjusting the sequence number of the incoming packets of the second network connection based on the second offset, where the splicing of the client-server network connection is transparent to the client and the server, where the NPU is hardware of the network device, and the NPU is configured to adjust the sequence number of the incoming packets. The storage medium also includes program instructions for sending the incoming packets to a destination after the adjusting.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1 illustrates the creation of a Transmission Control Protocol (TCP) connection, according to one embodiment.

FIG. 2 shows a network device in accordance with one or more embodiments.

FIG. 3 illustrates the configuration of the network processing unit (NPU) for processing packets from a spliced TCP connection, according to one embodiment.

FIG. 4 illustrates the flow of an incoming packet through the network device, according to one embodiment.

FIG. 5 illustrates the architecture of a distributed network device operating system (ndOS), according to one embodiment.

FIG. 6 illustrates load-balancing on a plurality of servers utilizing TCP splicing, according to one embodiment.

FIG. 7 is a flowchart for setting up the TCP spliced connection, according to one embodiment.

FIG. 8 is a flowchart for processing a packet belonging to the spliced TCP connection, according to one embodiment.

FIG. 9 is a flowchart for processing packets of a spliced a Transmission Control Protocol (TCP) connection.

FIG. 10 illustrates an exemplary embodiment of a network device.

FIG. 11 illustrates a resource coherency and analytics engine in accordance with one or more embodiments.

### DETAILED DESCRIPTION

The following embodiments describe methods, devices, systems, and computer programs for processing packets of a spliced Transmission Control Protocol (TCP) connection. One method includes an operation for splicing, by the network device, a client-server network connection by creating a first network connection between the client and the network device and a second network connection between the network device and the server. In addition, the method includes an operation for configuring in the network device a network processing unit (NPU) with a first offset for the first network connection and a second offset for the second network connection.

The switch fabric of the network device is configured to send incoming packets for the first network connection and the second network connection to the NPU for processing, which is able to process the packets in hardware for low latency. Additionally, the method includes an operation for adjusting, at the NPU, the sequence number of the incoming packets of the first network connection based on the first offset and adjusting the sequence number of the incoming packets of the second network connection based on the second offset, where the splicing of the client-server network connection is transparent to the client and the server. The incoming packets are then sent to the destination after being processed.

It will be apparent, that the present embodiments may be practiced without some or all of these specific details. In other instances, well-known process operations have not been described in detail in order not to unnecessarily obscure the present embodiments.

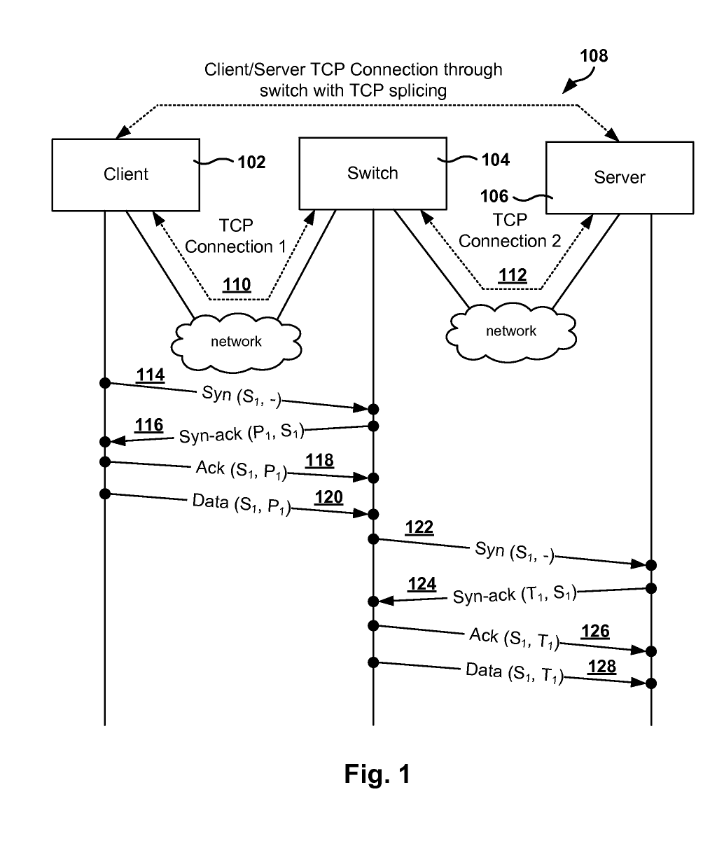

FIG. 1 illustrates the creation of a Transmission Control Protocol (TCP) connection, according to one embodiment. Typically, when a client 102 wants to connect to a server 106, a network connection 108 is established between the client 102 and the server 106. In one embodiment, the network connection is a TCP connection, a layer 4 network connection. Embodiments presented herein are described with reference to a TCP connection, but the principles may be utilized for any other network protocol used for communications between two entities.

In one embodiment, instead of establishing a single TCP connection 108 between the client 102 and the server 106, two TCP connections are created: a first TCP connection 110 between client 102 and switch 104 (also referred to as network switch or network device), and a second TCP connection 112 between switch 104 and server 106. From the point of view of the client and the server, there is only one TCP connection because the splicing of the TCP connection is transparent to the client and the server.

TCP is a network protocol that provides reliable, ordered, and error-checked delivery of a stream of octets between applications running on hosts communicating over an Internet protocol (IP) network. The TCP packet header includes several parameters and flags utilized to synchronize the reliable transfer of data between sender and receiver. These parameters include a sequence number (32 bits), also referred to as syn or syn number, an acknowledgment number (32 bits), also referred to as ack or ack number, and a checksum (16 bits).

The sequence number has a dual role: if the SYN flag is set (1), then this is the initial sequence number, and if the SYN flag is clear (0), then this is the accumulated sequence number of the first data byte of this segment for the current session. The acknowledgment number is the next sequence number that the receiver is expecting if the ack flag is set. It is used to acknowledge receipt of all prior bytes (if any). The first acknowledgment number sent by each end acknowledges the other end's initial sequence number itself, but no data. Further, the checksum is a field used for error-checking of the header and the data bits.

When splicing, the sequence and acknowledgment numbers are independent for each connection, although, in one embodiment, the network switch may establish a correlation between some of these parameters. Splicing the TCP connection allows the switch 104 to terminate the first connection 110 without having to wait for the backend server 106 to terminate the connection. Switch 104 changes the sequence number and/or the acknowledgment number of the packets as the packets go through the switch, in both directions.

In one embodiment, switch 104 is able to analyze the incoming packets, such as by looking at the layer-seven application data in the packets, and decide what action to take based on the layer-seven data. For example, switch 104 can select one server from a plurality of servers to terminate the TCP connection initiated by client 102.

To establish the TCP connection 108, client 102 sends 114 a syn packet to the server (e.g., at a well-known IP address) with the initial sequence number S₁. Switch 104 recognizes the packet as a packet to establish the connection with the server and determines that the TCP connection will be spliced. Therefore, switch 104 replies 116 to client 102 with a syn-ack packet with sequence number P₁ and an acknowledgment of S₁.

Upon receiving the syn-ack packet, client 102 replies 118 with an acknowledgment packet acknowledging the sequence number P₁. The connection is then established between client 102 and switch 104. The process to establish the connection is referred to as a three-way handshake. Afterwards, the client 102 is able to transmit data 120 over the TCP connection that includes the sequence numbers S₁ (data from client to switch) and P₁ (data from switch to client).

In one embodiment, after the data packet is received, the switch establishes the second TCP connection by sending 122 a syn packet to server 106. In one embodiment, the switch uses the same sequence number S₁ used by the client in the first TCP connection as the sequence number for the second connection, data going from switch 104 to server 106.

Similarly, the switch on the server performs a second three-way handshake 124, 126 to establish the second TCP connection 112, which includes sequence numbers S₁ (for data going from the switch to the server) and T₁ (for data going from the server to the switch). After the second connection is established, data received from the client is sent 128 to the server over the second TCP connection 112.

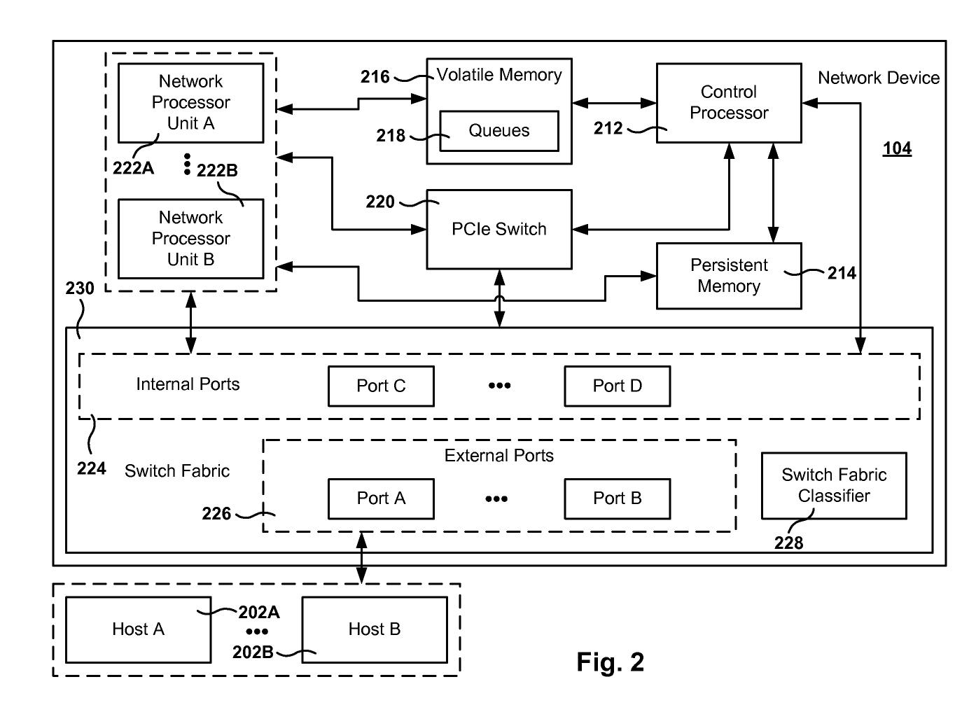

In one particular embodiment, the acknowledgment number is adjusted in the packets going from the client to the server, and the sequence numbers are adjusted in packets going from the server to the client. In one embodiment, after the initial setup of the connections, the switch 104 is configured to process the TCP packets in hardware to achieve low latency. In one embodiment, the hardware processing of the package is performed in a network processing unit (NPU), as discussed in more detail below with reference to FIGS. 2-4.

In summary, the switch first establishes the first connection with the client, and then the switch establishes the second connection with the server. At that point, the switch knows the differences between the sequence numbers and programs these differences into the NPU. Any new data packet that comes through the TCP connection will go through the NPU and the sequence numbers changed accordingly to splice the TCP connection.

The splicing off the connection requires extra resources at the network switch to maintain the two separate connections. Utilizing customized hardware (such as Asics) to do splicing is costly and does not provide redundancy since not every switch in the network can be used for the splicing. On the other hand, doing splicing in software is slow and the network device won't be able to support large amounts of traffic.

It is noted that the embodiments illustrated in FIG. 1 are exemplary. Other embodiments may utilize different sequence numbers, acknowledgment number, different sequence of messages for setting up the TCP splice connection, etc. The embodiments illustrated in FIG. 1 should therefore not be interpreted to be exclusive or limiting, but rather exemplary or illustrative.

FIG. 2 shows a network device in accordance with one or more embodiments. In one or more embodiments, the network device 104 includes external ports 226, internal ports 224, a switch fabric classifier 228, one or more network processing units (NPUs) 222A-222B, also referred to herein as packet processors, a control processor 212, persistent memory 214, a Peripheral Component Interconnect Express (PCIe) switch 220, switch fabric 230 and volatile memory 216.

In one embodiment, the network device 104 is any physical device in a network that includes functionality to receive packets from one network entity and send packets to another network entity. Examples of network devices include, but are not limited to, single-layer switches, multi-layer switches, and routers. Network entities correspond to any virtual or physical device on a network that is configured to receive packets and send packets. Examples of network entities include, but are not limited to, network devices (defined above), virtual machines, host operating systems natively executing on a physical device (also referred to as hosts, see, e.g., 202A, 202B), virtual network appliances (e.g., virtual switch, virtual router), and physical network appliances (e.g., firewall appliance).

The network device 104 (or components therein) may be implemented using any combination of hardware, firmware, and/or software. With respect to the hardware, the network device may be implemented using any combination of general purpose hardware and/or special purpose hardware (e.g., Field Programmable Gate Arrays (FPGAs), Application Specific Integrated Circuits (ASICs), etc.) and any type of storage and/or memory including, but not limited to, random access memory (RAM), dynamic random access memory (DRAM), static random access memory (SRAM), NAND-type flash memory, NOR-type flash memory, any other type of memory, any other type of storage, or any combination thereof.

In one embodiment, the switch fabric 230 includes one or more internal ports 224, one or more external ports 226, and the switch fabric classifier 228. In one embodiment, the switch fabric classifier 228 may be implemented using an on-chip or off-chip Ternary Content Addressable Memory (TCAM) or other similar components. In one embodiment, the internal and external ports correspond to virtual or physical connection points. In one embodiment, the switch fabric may be implemented using packet switching, circuit switching, another type of switching, or any combination thereof. The external ports 226 are configured to receive packets from one or more hosts 212A-212B and to send packets to one or more hosts 212A-212B. While FIG. 2 shows the external ports connected only to hosts 212A-212B, the external ports 226 may be used to send and receive packets from any network entity.

In one embodiment, the internal ports 224 are configured to receive packets from the switch fabric 224 and to send the packets to the control processor 212 (or more specifically, the ndOS executing on the control processor) and/or to an NPU (222A, 222B). Further, the internal ports are configured to receive packets from the control processor 212 (or more specifically, the ndOS executing on the control processor) and the NPUs (222A, 222B).

In one embodiment, the control processor 212 is any processor configured to execute the binary for the ndOS. In one embodiment, the NPU is a specialized processor that includes functionality to processes packets. In one embodiment, the NPU may be implemented as any combination of general purpose hardware and/or special purpose hardware (e.g., Field Programmable Gate Arrays (FPGAs), Application Specific Integrated Circuits (ASICs), etc.) and any type of storage and/or memory including, but not limited to, random access memory (RAM), dynamic random access memory (DRAM), static random access memory (SRAM), NAND-type flash memory, NOR-type flash memory, any other type of memory, any other type of storage, or any combination thereof. In one embodiment, the network device (104) may also include Field Programmable Gate Arrays (FPGAs) and/or Application Specific Integrated Circuits (ASICs) that are specifically programmed to process packets. In one embodiment, the network device may include FPGAs and/or ASICs instead of NPUs. In one embodiment, processing packets includes: (i) processing the packets in accordance with layer 2, layer 3 and/or layer 4 protocols (where all layers are defined in accordance with the OSI model), (ii) making a copy of the packet, (iii) analyzing (including decrypting and/or encrypting) the content of the header and/or payload in the packet, and/or (iv) modifying (including adding or removing) at least a portion of the header and/or payload in the packet.

In one embodiment, the switch fabric 230 is configured to: (i) send packets received from the internal ports 224 to the appropriate external ports 226 and (ii) send packets received from the external ports 226 to the appropriate internal ports 224.

In one embodiment, the switch fabric classifier 228 is configured to apply a classification rule to each packet received by the switch fabric to determine: (i) whether to send the received packet to an external port, (ii) whether to send the received packet to an internal port, and/or (iii) whether to send the received packet to the PCIe switch 220.

In one embodiment, the classification rule includes a classification criteria and an action. In one embodiment, the classification criteria specifies a media access control (MAC) address, an Internet Protocol (IP) address, a Transmission Control Protocol (TCP), user datagram protocol (UDP), an OSI layer 4 information related to a TCP ports, an IPSec security association (SA), a virtual local area network (VLAN) tag, a 802.1Q VLAN tag, or a 802.1Q-in-Q VLAN tag, or any combination thereof. In one embodiment, the action corresponds to an action to be performed when a packet satisfying the classification rule is identified. Examples of actions include, but are not limited to, (i) forward packet to the control processor (via a specific internal port or the PCIe switch), (ii) forward packet to an NPU (via a specific internal port or the PCIe switch), and (iii) send a copy of the packet to a specific external port, count the packet into one byte and packet counter or into a plurality of such counters based on further criteria such as packet size, latency, metadata such as physical ports for ingress or egress, etc., add meta data to any copied or forward packet such as timestamps, latency, physical ingress or egress path, etc.

In one embodiment, the switch fabric 230 is configured to communicate with the control processor 212 and/or the NPUs 222A-222B using a Peripheral Component Interconnect Express (PCIe). Those skilled in the art will appreciate the other hardware based switching frameworks/mechanisms may be used in place of (or in addition to) PCIe.

In one embodiment, the persistent memory 214 is configured to store the binary for the ndOS. The persistent memory 214 may be implemented using any non-transitory storage mechanism, e.g., magnetic storage, optical storage, solid state memory, etc.

In one embodiment, the volatile memory 216 is configured to temporarily store packets in one or more queues 218. The volatile memory may be implemented using any non-persistent memory, e.g., RAM, DRAM, etc. In one embodiment, each of the queues is configured to only store packets for a specific flow. In one embodiment, a flow corresponds to a group of packets that satisfy a given classification rule.

It is noted that the embodiments illustrated in FIG. 2 are exemplary. Other embodiments may utilize different communication interfaces (Ethernet, PCIe, PCI, etc.), network devices with less components or additional components, arrange the components in a different configuration, include additional interconnects or have fewer interconnects, etc. The embodiments illustrated in FIG. 2 should therefore not be interpreted to be exclusive or limiting, but rather exemplary or illustrative.

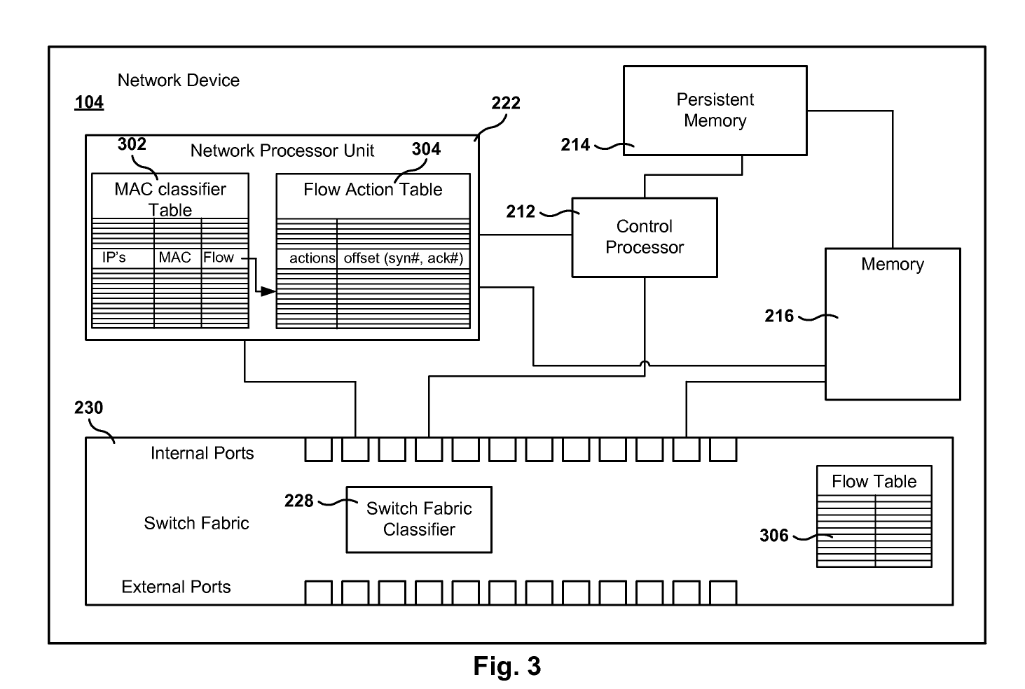

FIG. 3 illustrates the configuration of the network processing unit (NPU) for processing packets from a spliced TCP connection, according to one embodiment. In general, a network processing unit is a programmable integrated circuit for processing packet-based digital networking data. NPUs are used in many network processing applications, such as WAN/LAN switching and routing, switches and routers, load balancing, quality of service enforcement, voice over IP gateways, wireless infrastructure equipment, security (e.g., firewalls, virtual private networks, encryption, access control), and storage area networks.

Often NPUs include multi-threaded, multi-processor architectures for the parallel processing of network packets simultaneously. Further, NPUs are configurable to perform custom processing on network packets. For example, NPUs can be configured to perform layer 2 processing, RFC 1812 validation checks, virtual private network identification, source and destination IP lookups, packet classification based on packet content for one of multiple fields, or packet editing and header insertion or modification. For example, the NPU is able to analyze the content of a layer 7 header, and make a decision based on the content of the layer-seven header, such as selecting a web server for processing a web request. Further, the NPU is able to modify packet headers, such as by modifying IP or TCP headers based on the configuration of the NPU.

Many of the operations performed by the NPU are performed in hardware, which expedites the processing of the network packets, being able to accomplish much faster line rates than in conventional processing where packets are stored in RAM memory and a processor is used to examine the packet headers. The NPU is programmable hardware that is configured to do the TCP splicing. Because the packets are processed in hardware at the NPU, it is not necessary to load the packet, or part of the packet (e.g., one or more headers), in a processor for the processor to examine the contents of the packet and modify the TCP headers. For example, if the TCP splicing were performed by a processor, the processor would have to load from memory the content of the TCP header, modify the header by performing an addition (e.g., to modify the sequence number), and then overwrite the value of the header in memory with the result. This means that by performing the TCP splicing in hardware, it is not necessary to load programing instructions that are then executed by a processor to modify the necessary header fields.

It is noted that the NPU is not considered a general purpose processor, because the main purpose of the NPU is to process network packets. However, the NPU is programmable to perform network-packet process operations in hardware. In one embodiment, the NPU uses the contents of one or more hardware registers to perform the TCP splicing.

If TCP splicing is performed by control processor 212, the splicing of the TCP connection consumes a large amount of processor cycles, because the packet headers have to be loaded by the processor 212 and examined. Further, the control processor 212 has to modify the headers when necessary, including recalculating the checksums. In some networks, the control processor 212 would not be able to support the in line rates required for maintaining network traffic. In one embodiment, the TCP splicing is performed by the NPU 222, thereby freeing the resources in other components of the network device (e.g., control processor 212, memory 216 or switch fabric 230).

The NPU is able to process the packets of the sliced TCP connection utilizing hardware resources, instead of having to process the packets utilizing software and control processor 212. The hardware processing of the packets includes modifying certain fields in the TCP header in line, such as by adding an offset from a hardware register or recalculating a checksum. Therefore, the offset manipulation of the sequence number and the acknowledgment number in the TCP header is done in hardware without requiring a processor to perform the offset manipulation.

In one embodiment, the setup of the TCP spliced connection is done in software, as discussed above with reference to FIG. 1, and after the initial setup the packets are processed in hardware by the NPU 222.

In one embodiment, the network device 104 identifies flows and configures the processing of packets corresponding to each flow. For example, for a given flow, the network device may configure an action to perform network address translation. The actions for each of the flows may be performed by the switch fabric 230, or by control processor 212, by the network processor unit 222, or some other module in the switch.

In one embodiment, a separate flow is identified for each of the each TCP connections that form the TCP spliced connection. In one embodiment, the network device identifies a particular flow for the spliced TCP connection based on the source and destination IP address, and the source and destination TCP ports.

During setup, the flows for each of the TCP connections are configured so packets of the flows are subject to preconfigured actions. In one embodiment, the actions include one or more of the following:

1. Add a predetermined offset value to the sequence number of the TCP header, modulo 2³², to adjust for overflows of the sequence number, which is a 32-bit value.

2. Add a predetermined offset value to the acknowledgment number of the TCP header, modulo 2³².

3. Recalculate the checksum after any modification to the packet.

In one embodiment, the NPU 222 includes a Media Access Control (MAC) classifier table 302 that is used to identify flows. In one embodiment, the Flow classifier table 302 identifies a flow based on one or more of the source IP address, destination IP address, and MAC address of the destination in the packet. The NPU further includes a flow action table 304, that defines actions to be performed for each of the flows (the flow action table 304 may also include a flow field for linkage to the Flow classifier table 302). In one embodiment, Flow classifier table 302 is implemented in a Ternary Content Addressable Memory (TCAM) for quick identification of the flow associated with the packet.

When a packet comes to NPU 222, the Flow classifier table 302 identifies the flow associated with the packet, and the actions identified in the flow action table 304 for processing the packet are performed. In the case of a TCP spliced connection, the actions include adjusting the sequence and/or acknowledgment numbers in the TCP header and recalculating the checksum.

In another embodiment, the flow identification is performed by the switch fabric 230 by examining a flow table 306 in the switch fabric. In one embodiment, the flow table includes the same fields as the Flow classifier table 302 of NPU 222. In one embodiment, once the switch fabric identifies the flow of the packet, the switch fabric 230 notifies the NPU of which is the flow associated with the packet being transferred to the NPU for processing. In addition, the flow identification may also be performed by the control processor 212 by accessing a flow table stored in memory 216.

During the setup of the TCP spliced connection, the flows are defined and the actions of the flows configured in the flow action table 304, so the NPU 222 performs in hardware the processing required for the packets in the TCP spliced connection.

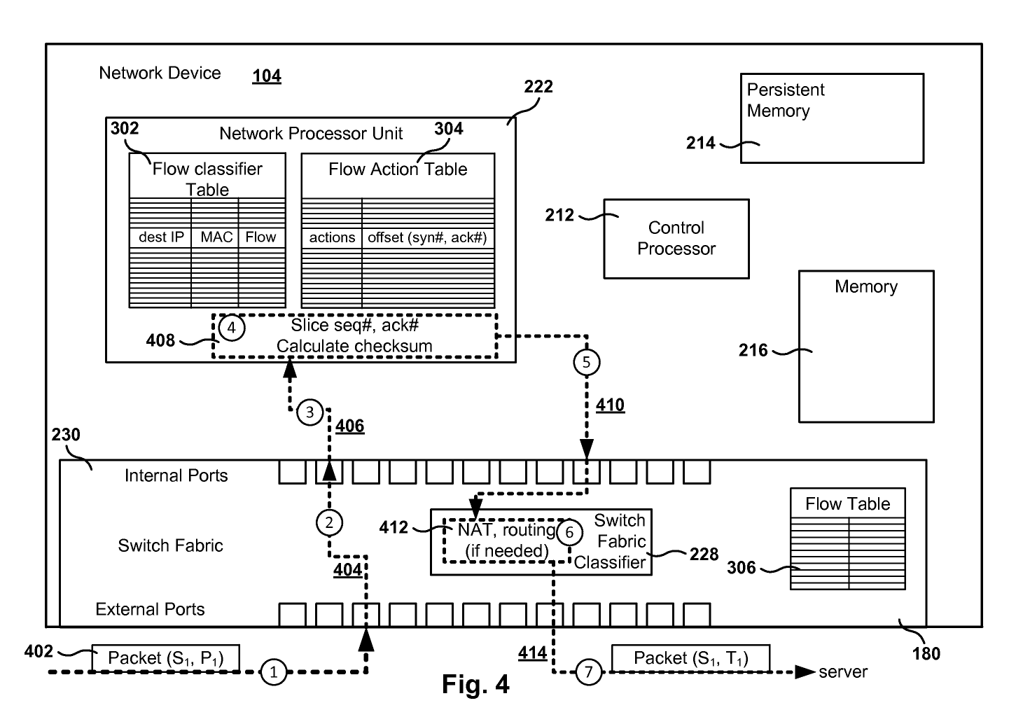

FIG. 4 illustrates the flow of an incoming packet through the network device, according to one embodiment. A packet 402 (having sequence number S₁ an acknowledgment number P₁) comes to the network device 104 through an external port into the switch fabric 230. The switch fabric identifies that the packet belongs to a TCP spliced connection and sends 404 the packet to an internal port. The internal port is connected to NPU 222, therefore the packet is transferred 406 to NPU 222.

The NPU then processes the packet 408, as discussed above, to modify the headers accordingly, in order to implement the TCP spliced connection. After the NPU 222 processes the packet by modifying one or more of the sequence number, acknowledgment number, and checksum, the packet is transferred 410 to an internal port of the switch fabric 230.

In one embodiment, the packet is received by the switch fabric after being processed by the NPU, and the packet is then sent to the destination without further processing. In another embodiment, the switch fabric performs 412 network address translation and/or routing on the packet at the switch fabric classifier 228. The packet is then sent 414 to an external port on its way to the server. The outgoing packet for the TCP connection between client and network device includes the sequence number S₁ and the acknowledgement number P₁. In yet another embodiment, the NPU performs the network address translation before the packet is sent to the switch fabric or directly to an external port. Network address translation involves changing the port numbers and one or more IP addresses. In one embodiment, the flow classifier table 302 is configurable to program actions to perform network address translation at the NPU.

The processing for the packets of the TCP connection between the server and the network device is similar, except that the sequence number and acknowledgment numbers would be S₁ and T₁ instead, as described in FIG. 1.

Processing the TCP spliced connection packets in hardware allows much faster processing of the packet than if the packet where processed in software, e.g., by utilizing control processor 212. The network device architecture allows the processing of packets quickly, offloading the processing to the NPU in order to provide quick inline parallel processing of packets.

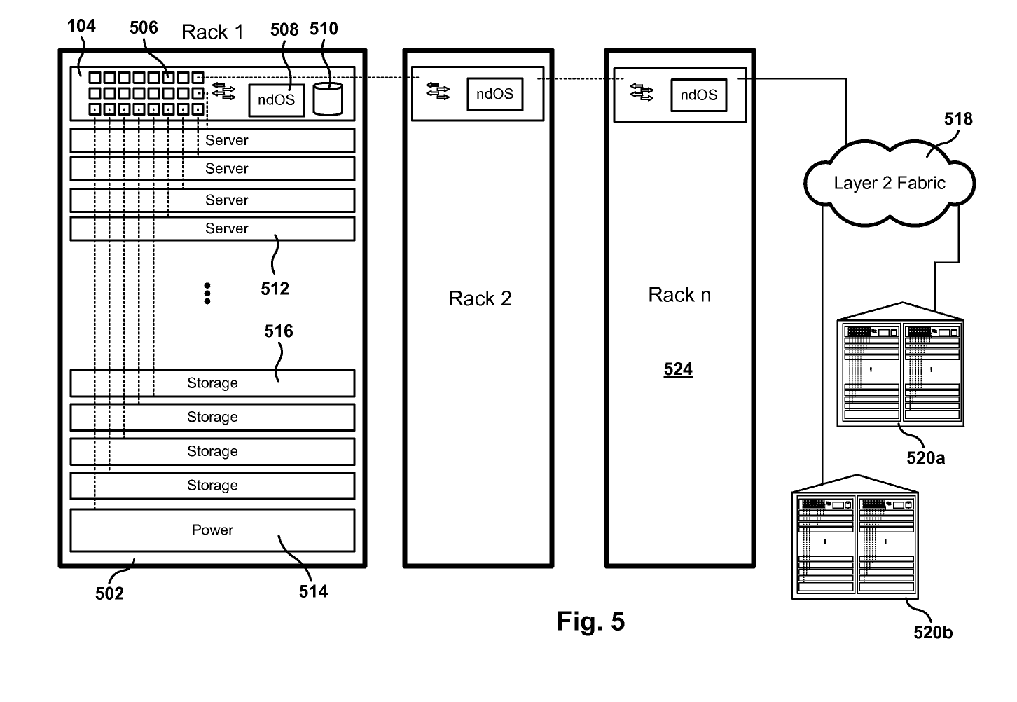

FIG. 5 illustrates the architecture of a distributed network device operating system (ndOS), according to one embodiment. The network environment of FIG. 5 includes a rack 202 with a plurality of servers 512, storage devices 516, power supplies 514, etc. In addition, rack 502 includes a switch 104.

Switch 104 includes an instance of the ndOS, permanent storage 510, and a plurality of Ethernet ports 506. The ndOS is a distributed network device operating system that spans a plurality of layer-2 devices (e.g., switches) across the network. The ndOS is also referred to herein as network operating system, layer-2 operating system, or distributed-switching operating system. An ndOS fabric is a collection of ndOS switches that share configuration and state information. Switches in a fabric work together to provision the resources allocated by the configuration and to manage state information across the fabric.

A switch running ndOS discovers other switches running ndOS using layer 2 and layer 3 discovery protocols. Each switch can be in its own fabric or the administrator can decide to join a switch to an existing fabric at any time. The ndOS fabric synchronizes the configuration and state across all switches in the fabric using TCP/IP.

When a ndOS switch comes up or any time a link changes state, ndOS uses a combination of LLDP messages, multicast, and routing protocols to discover switch adjacencies and underlying topology. The switches are not required to be connected directly but each switch knows the ports through which other switches are connected.

When coming up, a new ndOS switch goes through a short discovery phase to determine other fabrics that are visible directly or indirectly. As part of the ndOS switch setup, an administrator may choose to join an existing fabric and retrieve the configuration along with the transaction log from one of the switches in the fabric. In one embodiment, the fabric operates in synchronous mode for configuration, so it doesn't matter which switch the configuration is retrieved from. The joining of a new ndOS switch to a fabric is itself a fabric transaction so every switch is aware of the fact that a new switch has joined the fabric.

The interconnected switches with ndOS provide what appears to be a single logical switch that spans a plurality of switches, even switches located in geographically separated data centers 520a and 520b. The switches with ndOS build a layer-2 fabric that expands beyond a single switch and a single data center. As used herein, switching devices with ndOS are also referred to herein as ndOS switches or server-switches.

In one embodiment, configuration and state is shared between switches using a multi-threaded event queue over TCP/IP. When strict synchronization is required (for configuration changes or switching table updates in multi-path environments), ndOS employs a three-phase commit protocol to ensure consistency across all switches. To change the configuration across the fabric, all switches must participate and agree to the change. In one embodiment, if any switch is unreachable, the current implementation fails the operation and raises an event instructing the administrator to either manually evict the unreachable node or bring the unreachable node back on line. A switch that is manually evicted can rejoin the fabric and automatically synchronize configuration and state as part of rejoining the fabric. While a switch is unreachable, configuration changes are not allowed but the system still operates normally based on the existing configuration. In one embodiment, the fabric protocol uses TCP/IP for communication. The switches that make up a fabric can be separated by other switches, routers, or tunnels. As long as the switches have IP connectivity with each other, the switches can share fabric state and configuration.

An administrator or orchestration engine for a ndOS switch can create a hardware tunnel between two switches to provide layer 2 encapsulation over layer 3. Since ndOS switch chips support encapsulation/decapsulation in hardware, ndOS allows for tunneling layer 2 over layer 3 using a switch chip as an offload engine. The ndOS flow programming capability and encapsulation/decapsulation offload allows two virtual machines on the same layer 2 domain but separated by a layer 3 domain to communicate at line rates without any performance penalties.

As used herein, layer 2, named the data link layer, refers to the second layer of the OSI network model. In addition, it is noted that although the switches are described with reference to a layer 2 implementation, other layers in the OSI model may also be utilized to interconnect switches (e.g., remote switches may be connected via tunneling using an Internet protocol (IP) network), and some of the operations performed by the switches may expand into other layers of the OSI model. The layer 2 fabric is also referred to herein as the switch layer fabric or the layer 2 switch fabric.

The conceptual use of a single layer 2 fabric allows the creation of application specific flows and virtual networks with hardware-based isolation and hardware-based Service Level Agreements (SLAs). The scope of virtual networks and application flows can be restricted to individual switches (or ports within a switch) or can be extended to switch clusters and entire layer 2 fabrics. As a result, end-to-end resource management and guaranteed SLAs are provided.

In one embodiment, the ndOS manages the physical network boxes and the fabric (the collection of ndOS instances) of ndOS switches like a hypervisor manages an individual server. The ndOS can spawn isolated networks with guaranteed performance levels that are virtually indistinguishable from an application point of view, from a physical network. This functionality is similar to how a hypervisor spawns virtual machines that look and act as physical machines.

Switch management tools allow network administrators to manage the complete layer-2 fabric—such as viewing, debugging, configuring, changing, setting service levels, etc.—including all the devices in the layer-2 fabric. For example, individual switches may come online and automatically join the existing fabric. Once in the fabric, devices can be allocated into local, cluster, or fabric-wide pools. In a given pool of switches, resource groups (physical and virtual servers and virtual network appliances) are managed with defined policies that include definitions for bandwidth, latency, burst guarantees, priorities, drop policies, etc.

The ndOS, and the ndOS switches, may create application flows and virtual networks on the fabric. SLAs (e.g., access control lists (ACL), VLAN tags, guaranteed bandwidth, limits on bandwidth, guaranteed latency, priority on shared resources, performance of network services such as firewalls and load balances and others, etc.) become attributes of each application flow or virtual network. These attributes are managed by the network operating system, and virtual machines are free to communicate within the scope of their virtual networks.

In one embodiment, the ndOS switches include a switch fabric, a processor, permanent storage, and network packet processors, which enable massive classification and packet copying at line rates with no latency impact. The network operating system may dynamically insert probes with no hardware or physical reconfiguration at any point in the fabric and copy full or filtered packet streams to the ndOS itself with meta-information such as nanosecond level timestamps, ingress port, egress port, etc. As a result, fabric-wide snooping and analytics are both flexible and with no impact on performance.

In one embodiment, the ndOS captures streams (e.g., 40 Gbps per ndOS switch) and stores them on non-volatile storage (e.g., 1 terabyte). Rolling logs permit post-processing and re-creation of entire application flows across the fabric. The ndOS is also able to track link-level latency of each application and virtual network along with additional comprehensive statistics. In one embodiment, the statistics include which machine pairs are communicating, connection life-cycles between any machines, packet drops, queuing delays, etc. The network operating system tracks fine-grained statistics and stores them in permanent storage to permit inspection of history at a point in time or over a period of time. Further, the probe points may implement counters or copy the packets without adding any latency to the original stream, or the probes may increment double-buffered counters which can be direct memory mapped into the network operating system and allow user applications running on the switch to make real time decisions.

In one embodiment, the ndOS is also a hypervisor and thus can run standard network services like load balancers, firewalls, etc. Further, the ndOS allows switches to discover other switches. In one embodiment, all ndOS instances know about each other using a multicast-based messaging system. In one embodiment, ndOS switches periodically send multicast messages on a well-known address, the multicast messages including the senders' own IP address and a unique switch identifier (ID). In one embodiment, this multicast message is also utilized as a keep-alive message.

In addition, ndOS switches may create direct connections with each other to reliably exchange any information. Each ndOS instance keeps track of the local configuration information but also keeps track of global information (e.g., MAC address tables). An administrator is able to connect to any ndOS instance (using ndOS provided application programming interfaces (API) and other interfaces) and configure any particular switch, or change the global configuration or resource policies, which are reliably communicated to other ndOS instances in the fabric using a two-phase commit, or some other procedure. In phase 1 of the two-phase commit, resources are reserved and in phase 2 resources are committed. From the management perspective, the administrator has a global view of the entire layer-2 fabric and is able to apply local or global configuration and policies to any ndOS instance.

In one embodiment, the ndOS also enables administrators to configure notification of events related to changes in the fabric (e.g., switches being added or deleted), changes in link status, creation of virtual machines (VMs), creation, deletion, or modification of a network-hosted physical or virtual storage pool, etc. The clients can interact with an ndOS instance on a local switch, or on any switch in the fabric. The fabric itself reliably ensures that one or more switches get configured appropriately as needed.

It is noted that the embodiments illustrated in FIG. 5 are exemplary. Other embodiments may utilize different topologies, configuration, have a mixture of devices with ndOS and without ndOS, etc. The embodiments illustrated in FIG. 5 should therefore not be interpreted to be exclusive or limiting, but rather exemplary or illustrative.

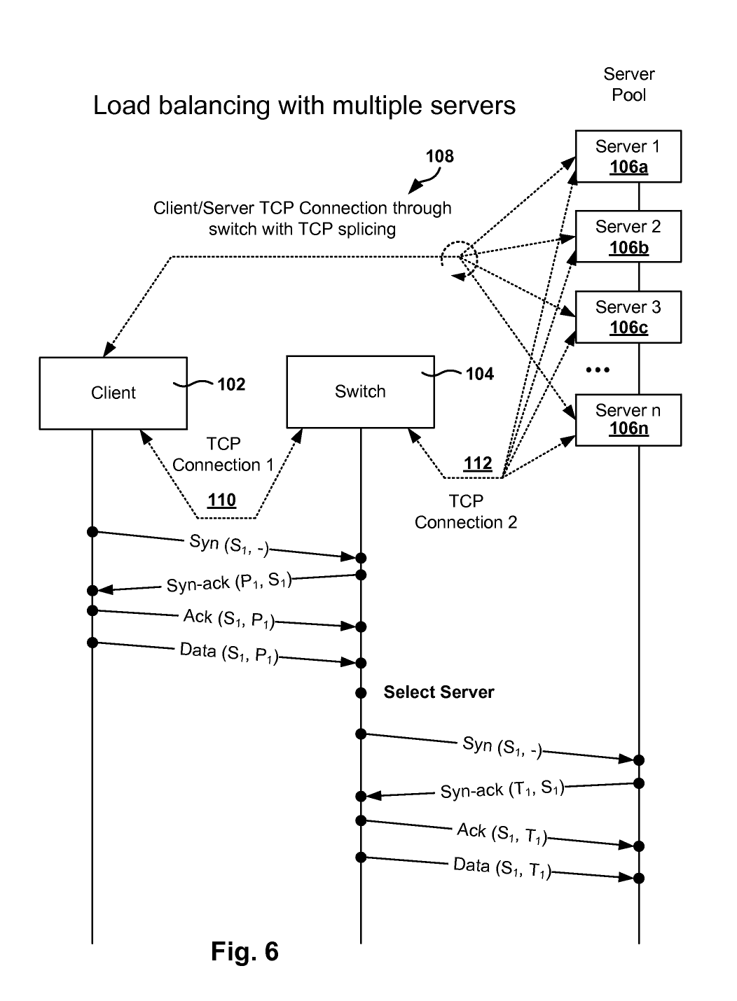

FIG. 6 illustrates load-balancing on a plurality of servers utilizing TCP splicing, according to one embodiment. TCP splicing is used in some applications for load balancing among a plurality of servers. In the exemplary configuration of FIG. 6, a plurality of servers 106a-106n is configured for providing a service to remote clients. In one embodiment, any of the servers may be used to provide the service to a client.

In one embodiment, the server configuration is transparent to the client, so from the point of view of the client there's only one server, e.g., accessed by its well-known Internet address or domain address. When the client wants to access the service, the client 102 establishes a TCP connection, and in one embodiment, the TCP connection is spliced for load-balancing.

After the initial three-way handshake to set up the first TCP connection 110, the switch 104 determines which of the servers will be utilized to terminate the TCP connection 108, or in other words, which of the servers will be used to establish the second TCP connection 112 between the switch 104 and the selected server.

In one embodiment, the switch 104 includes logic that interacts with one or more of the servers to identify the load on the servers, or any other criteria utilized to select a server when a client request is received. For example, in one embodiment, one or more of the servers is in communication with one or more of the ndOS switches to provide load information for the servers. In another embodiment, each of the servers communicates with one or more of the ndOS switches to provide load information.

When the first data packet of the first TCP connection 110 arrives to the switch, the switch 104 selects one of the servers and proceeds to perform the second three-way handshake with the selected server to establish the second TCP connection 112.

By allowing the switch 104, or a plurality of ndOS switches, to cooperate in selecting the server to terminate a connection, it is possible to offload the servers from performing the server selection. Also, the decision of which server to select is performed on the switch, which is closest to the client, resulting in less traffic, lower resource utilization, and better performance in the selection of the server.

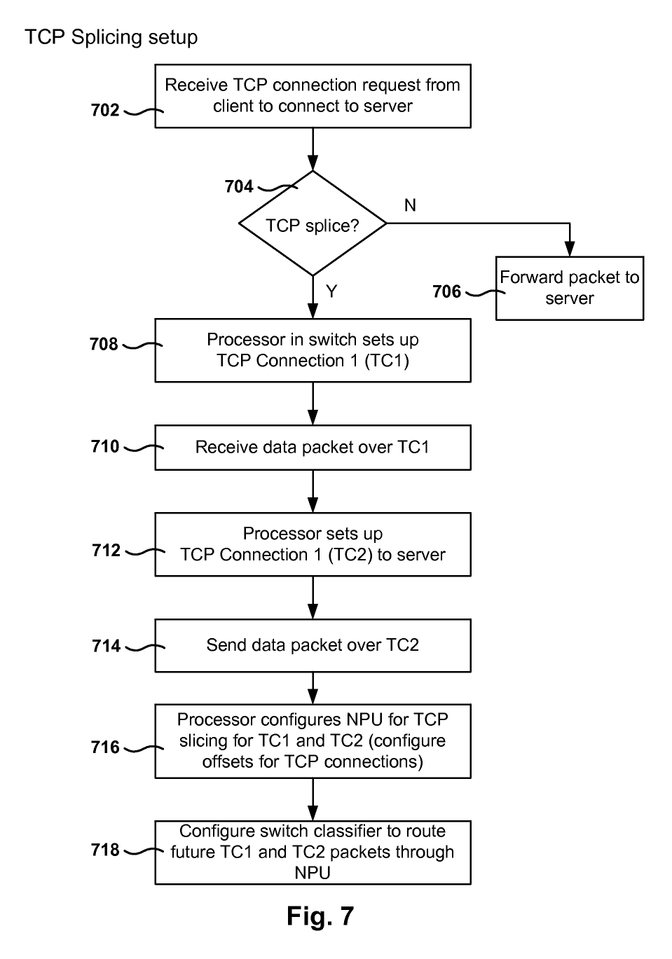

FIG. 7 is a flowchart for setting up the TCP spliced connection, according to one embodiment. While the various operations in the flowcharts of FIGS. 7-9 are presented and described sequentially, one of ordinary skill will appreciate that some or all of the operations may be executed in a different order, be combined or omitted, or be executed in parallel.

In operation 702, a TCP connection request is received at a network switch, the TCP connection request being from a client to connect to a server. From operation 702, the method flows to operation 704 where a check is made to determine if the TCP connection to connect the client to the server will be spliced. If the connection is not spliced, the method flows to operation 706, where the received packet is sent to the server. However, if the connection is to be spliced, the method flows to operation 708 where a processor in the switch sets up a first TCP connection (TC1).

From operation 708, the method flows to operation 710 where a data packet is received over TC1 after the three-way handshake establishing the TCP connection is completed. From operation 710, the method flows to operation 712 where the processor sets up a second TCP connection (TC2) between the switch and the server.

From operation 712, the method flows to operation 714 where the data packet is sent to the server order the second TCP connection TC2. From operation 714, the method flows to operation 716, where the processor configures the NPU to perform TCP splicing-related operations for both connections TC1 and TC2. For example, the processor configures offsets for the corresponding sequence numbers an acknowledgment numbers of both connections in the NPU.

From operation 716, the method flows to operation 718 where the switch classifier is configured in the network device to route future TC1 and TC2 received packets to the NPU for processing.

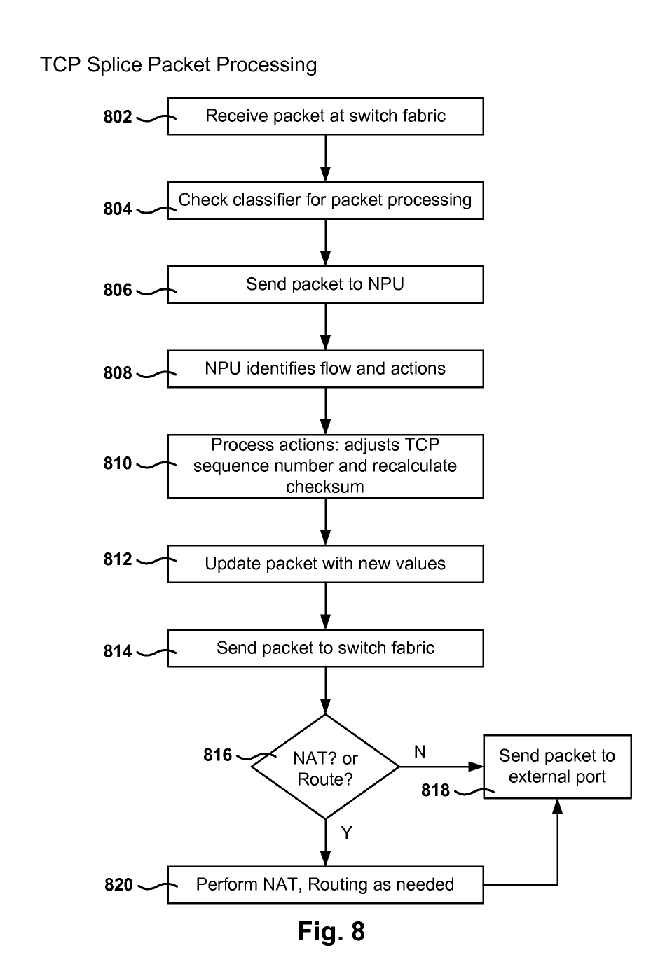

FIG. 8 is a flowchart for processing a packet belonging to the spliced TCP connection, according to one embodiment. In operation 802, a packet is received at the switch fabric. In operation 804, a packet classifier in the switch fabric checks for any processing instructions for the packet, if any (e.g., processing instructions for a TCP spliced connection).

From operation 804, the method flows to operation 806, where the packet received is sent to the NPU based on the instructions configured in the classifier in operation 804. In operation 808, the NPU identifies a flow associated with the received packet. The NPU checks if there are any actions identified with the flow.

From operation 808, the method flows to operation 810 where the actions identified in operation 808 are performed by the NPU. In one embodiment, the actions identified fo the flow including adjusting the TCP sequence number and recalculating the TCP checksum of the packet. In operation 812, the packet is modified to update the values identified by the actions performed on the packet.

From operation 812, the method flows to operation 814 where the packet is sent back from the NPU to the switch fabric. In operation 816, a check is made to determine if further processing is required on the packet, such as performing network address translation or routing of the packet. If no further action is required on the packet, the method flows to operation 818 where the packet is sent to an external port on his way to the destination. If the packet requires further processing, the method flows to operation 820 where the required actions are performed, such as performing network address translation and/or routing.

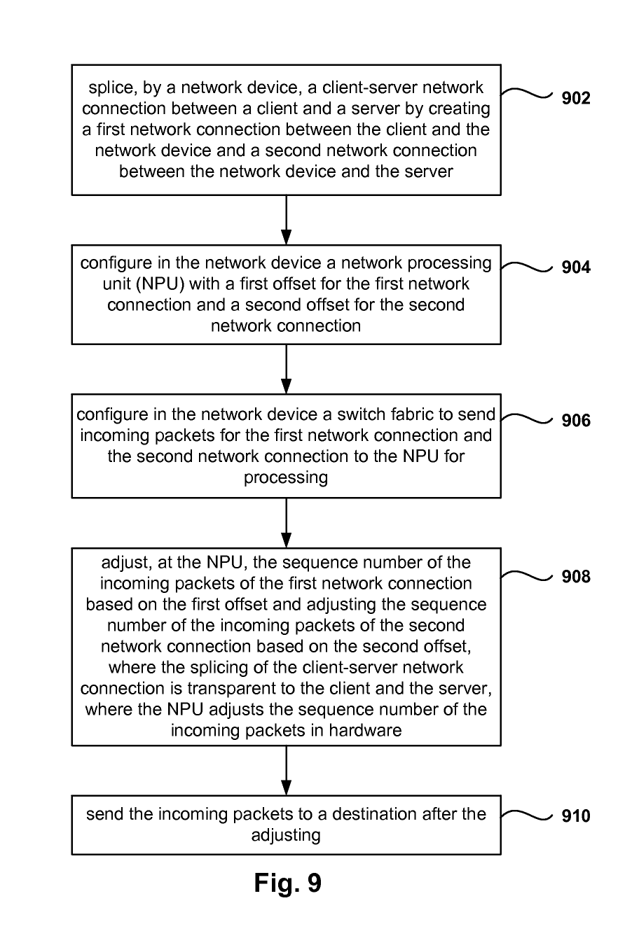

FIG. 9 is a flowchart for processing packets of a spliced a Transmission Control Protocol (TCP) connection. In operation 902, a client-server network connection is spliced by a network device by creating a first network connection between the client and the network device, and creating a second network connection between the network device and the server.

From operation 902, the method flows to operation 904 for configuring in the network device a network processing unit (NPU), where the NPU is configured with the first offset associated with the first network connection and the second offset associated with the second network connection.

From operation 904, the method flows to operation 906 for configuring the switch fabric in the network device. The switch fabric is configured to send the incoming packets for the first network connection and the second network connection to the NPU for processing.

From operation 906, the method flows to operation 908, where the sequence numbers of the incoming packets are adjusted at the NPU. The sequence numbers of the first network connection are adjusted based on the first offset, and the sequence number of the incoming packets of the second network connection are adjusted based on the second offset. The splicing of the client-server network connection is transparent to the client and to the server, and the NPU adjusts the sequence numbers of the incoming packets in hardware.

From operation 908, the method flows to operation 910 for sending the incoming packets to the destination after the corresponding sequence numbers have been adjusted at the NPU.

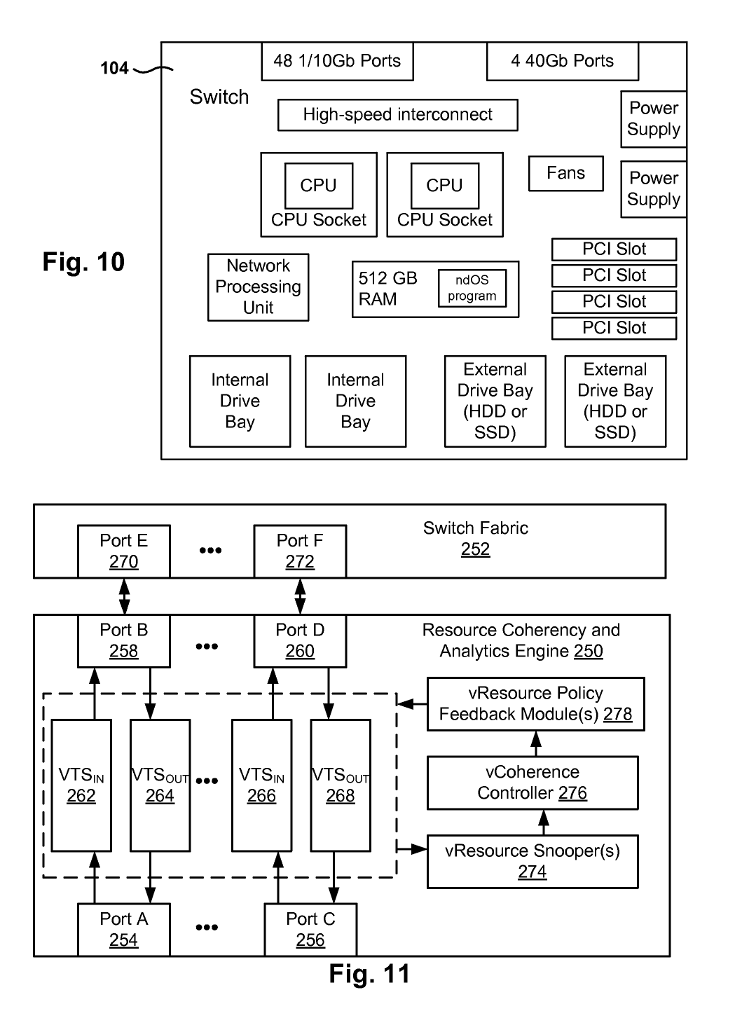

FIG. 10 illustrates an exemplary embodiment of a network device. The exemplary ndOS switch 104 includes a plurality of Ethernet ports (e.g., 48 1/10 Gb ports and 4 40 Gb ports), a high-speed interconnect that connects the internal modules within the switch (e.g., PCIe, Ethernet), and 2 CPU sockets for hosting 2 respective CPUs.

The ndOS switch 104 further includes a networking processing unit and RAM (e.g., 512 Gb), which may host the ndOS program while being executed by the one or more CPUs. The switch 104 further includes 2 drive bays for internal non-volatile storage, and 2 external drive bays for external storage (e.g., hard disk drive (HDD) or solid state drive (SSD)). Additionally, the ndOS switch 104 includes one or more power supplies, PCI slots (e.g., 4 PCI slots), and fans.

It is noted that the embodiment illustrated in FIG. 10 is exemplary. Other embodiments may utilize different components, have more or less amount of any of the components, include additional components, or omit one or more components. The embodiment illustrated in FIG. 10 should therefore not be interpreted to be exclusive or limiting, but rather exemplary or illustrative.

FIG. 11 illustrates a resource coherency and analytics engine in accordance with one or more embodiments. The Resource Coherency and Analytics engine (RCAE) 250 interacts with a switch fabric 272 in accordance with one or more embodiments. The RCAE 250 includes ports (e.g., 254, 256, 258, 260) configured to receive packets from a network (e.g., a wide area network (WAN), a local area network (LAN), the Internet) or the switch fabric 252 and to provide the packets to the appropriate virtual traffic shaper (VTS) (e.g., 262, 264, 266, 268). The ports in the RCAE may also be used to transmit packets to a network or to the switch fabric. The switch fabric 252 is configured to receive packets from and send packets to the RCAE via ports (e.g., 270, 272) in the switch fabric.

Each VTS is configured to process the packets received from the aforementioned ports and, if appropriate, send the packets to another port in the RCAE. The VTS processes the packets based on operating parameters set by the vCoherence Controller (VCC) 276. In one embodiment, the operating parameters may be determined based on one or more of the VRCLs (Virtual Resource Control Lists).

The operating parameters may include, but are not limited to, virtual output queue (VOQ) length, drain rate of VOQ (referred to as “drain rate”), cut-through policies, and VOQ scheduling policies. In one embodiment, the VOQ length corresponds to a maximum number of packets that may be queued in the VOQ at any one time. In one embodiment, the drain rate corresponds to the rate at which packets queued in a given VOQ are removed from the VOQ and scheduled for transmission. The drain rate may be measured as data units/unit time, e.g., megabits/second. In one embodiment, cut-through policies correspond to policies used to determine whether a given packet should be temporarily stored in a VOQ or if the packet should be sent directly to a VOQ drainer. In one embodiment, VOQ scheduling policies correspond to policies used to determine the order in which VOQs in a given VTS are processed.

The VCC 276 obtains RCAE statistics from the vResource Snooper (VRS) 274 and uses the RCAE statistics to update and/or modify, as necessary, the operating parameters for one or more VTSs in the RCAE. In one embodiment, the VCC 276 may obtain RCAE statistics directly from the individual VTSs. Those skilled in the art will appreciate that other mechanisms may be used to obtain the RCAE statistics from the VTS by the VCC without departing from the embodiments.

In some embodiments, the VCC 276 includes functionality to obtain RCAE statistics from all VRSs 274 in the RCAE and then to change the drain rates (described below) for one or more VOQ drainers based on the RCAE statistics obtained from all (or a portion) of the VTSs. The VCC 276 may also provide particular RCAE statistics to the VTS or components within the VTS, e.g., the VRCL enqueuer and VOQ Drainer, in order for the VTS (or components therein) to perform their functions.

The RVS 274 is configured to obtain RCAE statistics from the individual VTSs. The RCAE statistics may include, but are not limited to, (i) packets received by VTS, (ii) packets dropped by VRG (virtual resource group) classifier, (iii) packets dropped by the VRCL enqueuer, (iv) packets queued by each VOQ in the VTS, (v) number of cut-through packets, (vi) queue length of each VOQ in the VTS, (vi) number of packets scheduled for transmission by VOQ drainer, and (vii) latency of VTS. The RCAE statistics may be sent to the VRS 274 as they are obtained or may be sent to the VRS 274 at various intervals. Further, the RCAE statistics may be aggregated and/or compressed within the VTS prior to being sent to the VRS 274.

In one embodiment, updates or modifications to the operating parameters of the one or more VTSs are sent to the vResource Policy Feedback Module (RPFM) 278. The RPFM 278 communicates the updates and/or modifications of the operating parameters to the appropriate VTSs. Upon receipt, the VTSs implement the updated and/or modified operating parameters. In another embodiment, any updates or modifications to the operating parameters of the one or more VTSs are sent directly to the VTSs from the VCC.

Embodiments of the present disclosure may be practiced with various computer system configurations including hand-held devices, microprocessor systems, microprocessor-based or programmable consumer electronics, minicomputers, mainframe computers and the like. The embodiments can also be practiced in distributed computing environments where tasks are performed by remote processing devices that are linked through a network.

With the above embodiments in mind, it should be understood that the embodiments can employ various computer-implemented operations involving data stored in computer systems. These operations are those requiring physical manipulation of physical quantities. Any of the operations described herein are useful machine operations. The embodiments also relate to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g., a cloud of computing resources.

One or more embodiments can also be fabricated as computer readable code on a non-transitory computer readable storage medium. The non-transitory computer readable storage medium is any non-transitory data storage device that can store data, which can be thereafter be read by a computer system. Examples of the non-transitory computer readable storage medium include hard drives, network attached storage (NAS), read-only memory, random-access memory, CD-ROMs, CD-Rs, CD-RWs, magnetic tapes and other optical and non-optical data storage devices. The non-transitory computer readable storage medium can include computer readable storage medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method comprising:
splicing, by a network device, a client-server network connection between a client and a server by creating a first network connection between the client and the network device and a second network connection between the network device and the server;
configuring in the network device a network processing unit (NPU) with a first offset for the first network connection and a second offset for the second network connection;
configuring in the network device a switch fabric to send incoming packets for the first network connection and the second network connection to the NPU for processing;
adjusting, at the NPU, a sequence number of the incoming packets of the first network connection based on the first offset and adjusting a sequence number of the incoming packets of the second network connection based on the second offset, wherein the splicing of the client-server network connection is transparent to the client and the server, wherein the NPU is hardware of the network device, and the NPU is configured to adjust the sequence number of the incoming packets; and
sending the incoming packets to a destination after the adjusting.

2. The method as recited in claim 1, further including:
adjusting, at the NPU, an acknowledgment number of the incoming packets of the first network connection based on a first acknowledgment number offset value and adjusting an acknowledgment number of the incoming packets of the second network connection based on a second acknowledgment number offset value.

3. The method as recited in claim 1, further including
modifying, at the NPU, a checksum of the incoming packets after the adjusting.

4. The method as recited in claim 1, wherein splicing the client-server network connection further includes:
performing a first three-way handshake between the client and the network device to create the first network connection; and
performing, after performing the first three-way handshake, a second three-way handshake between the network device and the server to create the second network connection.

5. The method as recited in claim 4, further including:
after performing the first three-way handshake, selecting the server from a plurality of servers; and
performing the second three-way handshake with the selected server.

6. The method as recited in claim 1, further including:
performing, at the NPU, network address translation for the incoming packet.

7. The method as recited in claim 1, further including:
after adjusting the sequence number of the incoming packets, sending the incoming packets to the switch fabric.

8. The method as recited in claim 7, further including:
performing, at the switch fabric, network address translation for the incoming packet.

9. The method as recited in claim 1, wherein configuring the NPU further includes:
initializing a register in the NPU with the first offset, wherein the NPU accesses the register to adjust the incoming packets from the first network connection to perform the adjustment in hardware.

10. The method as recited in claim 1, wherein adjusting the incoming packets of the first network connection includes:
changing the sequence number of the incoming packets of the first network connection to be incremented by the first offset.

11. The method as recited in claim 1, wherein the client-server network connection, the first network connection, and the second network connection are transmission control protocol (TCP) connections, wherein the sequence number is a TCP sequence number.

12. A network device comprising:
a network processing unit (NPU) for processing packets in the network device;
a switch fabric for processing packets within the network device; and
a processor configured to splice a client-server network connection between a client and a server by creating a first network connection between the client and the network device and a second network connection between the network device and the server;
wherein the processor configures the NPU with a first offset for the first network connection and a second offset for the second network connection, and the processor configures the switch fabric to send incoming packets for the first network connection and the second network connection to the NPU for processing;
wherein the NPU is configured to adjust a sequence number of the incoming packets of the first network connection based on the first offset and adjust the sequence number of the incoming packets of the second network connection based on the second offset, wherein the splicing of the client-server network connection is transparent to the client and the server, wherein the NPU is hardware of the network device, and the NPU is configured to adjust the sequence number of the incoming packets;
wherein the switch fabric is configured to send the incoming packets to a destination after the NPU adjusts the sequence number of the incoming packets.

13. The network device as recited in claim 12, wherein the NPU is configured to adjust an acknowledgment number of the incoming packets of the first network connection based on a first acknowledgment number offset value and to adjust an acknowledgment number of the incoming packets of the second network connection based on a second acknowledgment number offset value.

14. The network device as recited in claim 12, wherein the NPU is configured to modify a checksum of the incoming packets after adjusting the sequence number of the incoming packets.

15. The network device as recited in claim 12, wherein when splicing the client-server network connection the processor performs a first three-way handshake between the client and the network device to create the first network connection, and the processor performs, after performing the first three-way handshake, a second three-way handshake between the network device and the server to create the second network connection.

16. The network device as recited in claim 15, wherein the processor is configured to select the server from a plurality of servers after performing the first three-way handshake, and the processor is configured to perform the second three-way handshake with the selected server.

17. The network device as recited in claim 12, wherein the NPU is configured to send the incoming packets to the switch fabric after adjusting the sequence number of the incoming packets.

18. A non-transitory computer-readable storage medium storing a computer program for processing network packets at a network device, the computer-readable storage medium comprising:
program instructions for splicing, by a network device, a client-server network connection between a client and a server by creating a first network connection between the client and the network device and a second network connection between the network device and the server;
program instructions for configuring in the network device a network processing unit (NPU) with a first offset for the first network connection and a second offset for the second network connection;
program instructions for configuring in the network device a switch fabric to send incoming packets for the first network connection and the second network connection to the NPU for processing;
program instructions for adjusting, at the NPU, a sequence number of the incoming packets of the first network connection based on the first offset and adjusting the sequence number of the incoming packets of the second network connection based on the second offset, wherein the splicing of the client-server network connection is transparent to the client and the server, wherein the NPU is hardware of the network device, and the NPU is configured to adjust the sequence number of the incoming packets; and
program instructions for sending the incoming packets to a destination after the adjusting.

19. The storage medium as recited in claim 18, further including:
program instructions for adjusting, at the NPU, an acknowledgment number of the incoming packets of the first network connection based on a first acknowledgment number offset value and adjusting an acknowledgment number of the incoming packets of the second network connection based on a second acknowledgment number offset value.

20. The storage medium as recited in claim 18, further including program instructions for modifying, at the NPU, a checksum of the incoming packets after the adjusting.

21. The storage medium as recited in claim 18, wherein splicing the client-server network connection further includes:
performing a first three-way handshake between the client and the network device to create the first network connection; and
performing, after performing the first three-way handshake, a second three-way handshake between the network device and the server to create the second network connection.
